(19) United States
(12) Patent Application Publication
(10) Pub. No.: US 2026/0093805 A1
(43) Pub. Date: Apr. 2, 2026

(54) Generic Detection of Malicious Abuse of Startup Persistence

(71) Applicant: Palo Alto Networks, Inc., Santa Clara, CA (US)

(72) Inventors: Matan Haim Guez, Rishon LeZion (IL); Yuval Zan, Givatayim (IL); Erez Levy, Ganei Tikva (IL); Ofir Ozer, Tel Aviv (IL)

(21) Appl. No.: 18/903,022

(22) Filed: Oct. 1, 2024

(51) Int. Cl. G06F 21/55; G06F 21/56

(52) U.S. Cl. CPC G06F 21/554; G06F 21/566

(57) ABSTRACT

A cyber-security method includes selecting for analysis a software process running in a computing platform. The process is classified into a class among a set of classes, depending on (i) whether a security identifier of the process is unique, and (ii) whether a root parent process of the process is an operating-system executable process. One or more statistical tests are applied to the process, the statistical tests depending on the class. Based on a result of the statistical tests, a decision is made that the process is suspected of being a malicious process that has been set-up to persist following reboot of the computing platform, and a responsive action is initiated.

### FIELD OF THE INVENTION

The present invention relates generally to cyber-security, and particularly to methods and systems for detecting malicious attacks employing startup persistence.

### BACKGROUND OF THE INVENTION

Operating Systems (OSs) such as Microsoft Windows® provide mechanisms that enable software programs to survive rebooting. Such mechanisms are referred to herein as “startup persistence” or simply “persistence”. Persistence mechanisms can be abused by malware or other cyber-security threats to remain operative on a compromised platform for long periods of time regardless of rebooting. Long-term attacks that use persistence mechanisms are referred to as “Advanced Persistent Threats” (APTs).

### SUMMARY OF THE INVENTION

An embodiment of the present invention that is described herein provides a cyber-security method including selecting for analysis a software process running in a computing platform. The process is classified into a class among a set of classes, depending on (i) whether a security identifier of the process is unique, and (ii) whether a root parent process of the process is an operating-system executable process. One or more statistical tests are applied to the process, the statistical tests depending on the class. Based on a result of the statistical tests, a decision is made that the process is suspected of being a malicious process that has been set-up to persist following reboot of the computing platform, and a responsive action is initiated.

In some embodiments, selecting the process includes identifying that the process was initiated within a defined time duration from booting of the computing platform.

In an example embodiment, classifying the process includes (i) upon finding that the security identifier is unique, deciding that the security identifier is indicative that the process was initiated automatically by an operating system, and (ii) upon finding that the security identifier is non-unique, deciding that the security identifier is indicative that the process was not initiated automatically by the operating system.

In an embodiment, the method further includes, upon deciding that the process is suspected of being a malicious process, running one or more cyber feature tests to assess a severity measure for the process. In an embodiment, the method further includes, upon deciding that the process is suspected of being a malicious process, determining a persistence mechanism that was used for setting up persistence for the process.

There is additionally provided, in accordance with an embodiment that is described herein, a cyber-security system including an input interface and one or more processors. The input interface is configured to receive events indicative of software processes that run in one or more computing platforms. The one or more processors are configured to select for analysis a software process running in a computing platform, to classify the process into a class among a set of classes, depending on (i) whether a security identifier of the process is unique, and (ii) whether a root parent process of the process is an operating-system executable process, to apply one or more statistical tests to the process, the statistical tests depending on the class, and, based on a result of the statistical tests, to decide that the process is suspected of being a malicious process that has been set-up to persist following reboot of the computing platform, and to initiate a responsive action.

There is further provided, in accordance with an embodiment that is described herein, a computer software product, the product including a tangible non-transitory computer-readable medium in which program instructions are stored, which instructions, when read by one or more processors, cause the one or more processors to select for analysis a software process running in a computing platform, to classify the process into a class among a set of classes, depending on (i) whether a security identifier of the process is unique, and (ii) whether a root parent process of the process is an operating-system executable process, to apply one or more statistical tests to the process, the statistical tests depending on the class, and, based on a result of the statistical tests, to decide that the process is suspected of being a malicious process that has been set-up to persist following reboot of the computing platform, and to initiate a responsive action.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for detecting persistent cyber-security threats, in accordance with an embodiment of the present invention; and

FIG. 2 is a flow chart that schematically illustrates a method for detecting persistent cyber-security threats, in accordance with an embodiment of the present invention.

### DETAILED DESCRIPTION OF EMBODIMENTS

### Overview

Launching a persistent threat typically includes two phases—setup and execution. The setup phase involves configuring the OS of a computing platform to provide persistence to a malicious payload. The execution phase involves the actual execution of the malicious payload on the computing platform, taking advantage of the persistence that was previously set up.

The OS typically includes a large number of components that can be abused by attackers to set up persistence. The number of possibilities for setting up persistence is therefore very large, and, in reality, new malicious persistence set-up techniques are constantly being developed. Detection of the setup phase is therefore highly challenging. The challenge is worsened by the fact that the setup phase typically occurs only once on a given platform. Moreover, the setup phase will typically differ from one persistence mechanism to another. If the setup phase goes undetected, the malicious payload may remain operative for years.

Embodiments of the present invention that are described herein provide improved techniques for detecting persistent cyber-security threats, by focusing on the execution phase rather than on the setup phase. In other words, the disclosed techniques detect executions of malicious processes that are suspected of employing a previously abused persistence mechanism.

The disclosed techniques are generic, in the sense that they do not attempt to detect a specific attack signature, and are therefore capable of detecting previously unknown attacks. Since the execution phase occurs on every boot of the platform, the disclosed techniques achieve a very high detection probability.

In some embodiments, a persistent threat detection system (“detection system”) is assigned to protect a computer system (“protected system”) against persistent cyber-security threats. In an example implementation the detection system is cloud-based and is assigned to protect multiple different computer systems (“tenants”).

The detection system receives events from the protected system. Some of the events indicate starting of execution of processes in the various computing platforms of the protected system. As an initial filtering criterion, the detection system selects for further analysis processes that started within a defined time duration (e.g., five minutes) from booting of the respective platform. The underlying assumption is that the execution phase of a persistent threat is likely to start shortly after booting of the platform.

Having detected a process that started shortly after boot, the detection system classifies the process into one of four classes, using two classification criteria:
A first criterion checks whether a Security Identifier (SID) of the process is a unique SID or a non-unique SID. A unique SID (i.e., a SID assigned to OS entities and are part of the OS) is typically indicative of a process that was started automatically by the OS (e.g., by a system component, service or process). A non-unique SID (i.e., a SID assigned to a system entity created by a local/domain user) is typically indicative of a process that was not started automatically by the OS (but rather, for example, directly or indirectly by a user).
A second criterion checks whether the “causality actor” of the process is an OS executable process (e.g., Windows binary) or not. The term “causality actor”, or simply “causality”, refers to the root parent process of the process being evaluated. In other words, the second criterion checks whether the process was spawned by a process of the OS.

Thus, in an embodiment, the detected process is classified into one of four classes: (i) unique SID, causality is an OS executable process, (ii) unique SID, causality is not an OS executable process, (iii) non-unique SID, causality is an OS executable process, and (iv) non-unique SID, causality is not an OS executable process.

After classifying the process, the detection system subjects the process to one or more statistical tests that depend on the class. The goal of the class-specific statistical tests is to choose certain characteristics of the process, and to estimate how prevalent (commonly occurring) these characteristics are among the processes of that class. The measure of prevalence may be local (i.e., within the processes belonging to the same tenant) and/or global (i.e., within the processes belonging to multiple tenants, e.g., all tenants). Research has shown that it is highly advantageous to define a separate set of statistical tests for each of the four classes defined above. In some embodiments, one or more of the tests are common to all the classes. In some embodiments, one or more of the tests are class specific, i.e., unique for a given class.

By applying the statistical tests, the detection system estimates whether the characteristics of the process are prevalent (common) or non-prevalent (rare). The rationale behind this criterion is that a process having rare characteristics is more likely to be malicious than a process having commonly occurring characteristics. Thus, the detection system uses the results of the statistical tests to decide whether the process is suspected of being an execution of a persistent threat. If suspected, the detection system initiates a responsive action, e.g., issues an alert.

In some embodiments, the detection system enriches the alert with additional useful information. For example, the detection system may perform various cyber feature checks to estimate the severity of the alert. As another example, the detection system may be able to determine which OS persistence mechanism was used for setting up the persistence for the process. The latter technique is effective in detecting previously unknown modes of persistence threat setup.

### System Description

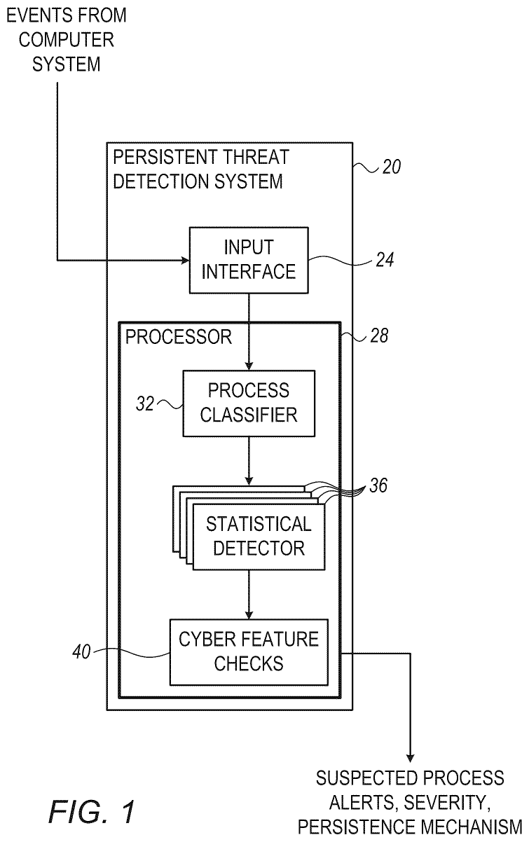

FIG. 1 is a block diagram that schematically illustrates a system 20 for detecting persistent cyber-security threats, in accordance with an embodiment of the present invention. System 20 is typically assigned to protect a computer system (referred to as a “protected system”—not seen in the figure) against malicious attacks, including persistent threats.

In the present context, the term “security threat” refers to any software that runs on one or more computing platforms of the protected system for a malicious purpose. A security threat may cause damage by itself (e.g., destroy of extract information), or it can be a tool that aids an attacker, e.g., to infiltrate a platform or deliver malicious code. The term “computing platform”, or simply “platform”, is used herein to refer to any device that can be compromised by security threats. Non-limiting examples of computing platforms include endpoint computers, servers, network devices, individual Central Processing Units (CPUs) or other processors, and the like. A computing platform may be physical or virtual (e.g., a Virtual Machine (VM)). A computing platform, or even the entire protected system, may be entirely cloud-based.

In the embodiment of FIG. 1, system 20 comprises an input interface 24 and one or more processors 28. The description that follows refers to a single processor 28, for clarity. Input interface 24 receives various events from the protected system. Processor 28 uses the events to automatically detect persistent cyber-security threats, using methods that are described below. Upon detecting a suspected persistent threat, processor 28 outputs an alert. The alert may be enriched with (i) a quantitative severity score (e.g., low/medium/high severity), and/or an identification of the persistence mechanism being abused.

In the present example, processor 28 runs a process classifier 32, a plurality of statistical detectors 36, and cyber feature checks 40. The functions of these modules are explained in detail below.

The configuration of system 20 shown in FIG. 1 is an example configuration, which is chosen purely for the sake of conceptual clarity. In alternative embodiments, any other suitable configuration can be used. For example, the tasks of processor 28 may be split among multiple processors. Elements that are not necessary for understanding the principles of the present invention have been omitted from the figures for clarity.

The various elements of system 20 may be implemented in hardware, e.g., in one or more Application-Specific Integrated Circuits (ASICs) or FPGAs, in software, or using a combination of hardware and software elements. Processors 28 may comprise one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

### Generic Detection of Persistent Threats

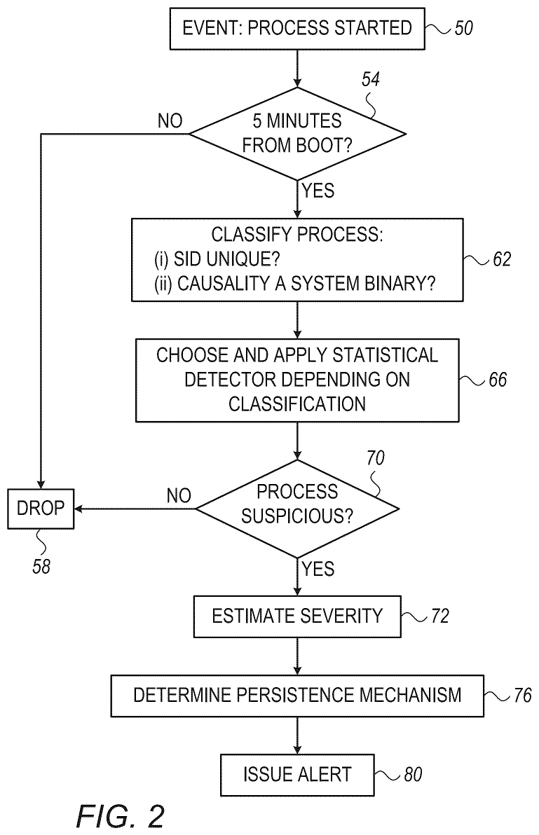

FIG. 2 is a flow chart that schematically illustrates a method for detecting persistent cyber-security threats, in accordance with an embodiment of the present invention. The goal of the method is to detect whether processes that carry out the execution phases of persistent threats that were previously set up on platforms of the protected system.

The method begins with detection system 20 receiving events from the protected system, via input interface 24. At an input stage 50, system 20 receives an event indicating that a process has started execution on a certain platform of the protected system. The event is provided to processor 28.

At an initial filtering stage 54, processor 28 checks whether the process started within a defined time duration from booting of the respective platform. In the present example, the defined time duration is five minutes. Alternatively, however, any other suitable duration can be used. If the process was started more than the defined time duration from booting of the platform, processor 28 drops the event, at a dropping stage 58, and the method terminates.

If stage 54 indicates that the process was started shortly after booting of the platform, processor 28 proceeds to classify the process using classifier 32, at a classification stage 62. Classifier 32 classifies the process by evaluating two classification criteria:
A first criterion checks whether the SID of the process is unique, or whether the SID is non-unique. As explained above, this criterion distinguishes between processes that are likely to have been initiated automatically by the OS, and processes that were not initiated automatically by the OS (but rather, for example, directly or indirectly by a user).
A second criterion checks whether the causality actor of the process is an OS executable process (e.g., Windows binary) or not. (Processes are typically arranged hierarchically in trees having parent-child relationships, wherein a child process is invoked by a parent process. The process located at the root of the tree is referred to as the “causality” of the processes in the tree. A process that does not have any parent or children is considered its own causality.)

Using these criteria, classifier 32 classifies the process into one of the following four classes:
Processes whose SID is unique, and whose causality is an OS executable process (e.g., a Windows binary process).
Processes whose SID is non-unique, and whose causality is an OS executable process.
Processes whose SID is unique, and whose causality is not an OS executable process.
Processes whose SID is non-unique, and whose causality is not an OS executable process.

At a statistical filtering stage 66, processor 28 selects one of statistical detectors 36 for applying to the process, and applies the selected statistical filter. In the present example, processor 28 comprises four detectors 36, each detector assigned respectively to one of the four classes. Processor 28 chooses the detector 36 that corresponds to the class of the process, as decided at stage 62.

Each detector 36 comprises one or more statistical tests that estimate the level of prevalence of the characteristics of the process. Typically, a process whose characteristics are prevalent (commonly occurring) is likely to be benign. A process whose characteristics are non-prevalent (rare) is more likely to be malicious. The statistical tests of detectors 36 may consider any suitable characteristic of the process. Several non-limiting examples of tests include the following:
Entities context characteristics: Statistical tests on characteristics of the causality (root parent process) of the process being evaluated. Characteristics may comprise, for example, names, paths and/or arguments of one or more processes in the causality tree of the evaluated process. Such tests may evaluate whether the context of a process, which was executed in the early startup stage, is prevalent (and therefore likely to be innocent) or rare (and therefore may be suspicious). Two non-limiting examples of entities context characteristics tests comprise the following:
   How many protected systems (tenants) reported a process execution event at the early startup stage, in which the paths of a specified causality process and the process executed with specified arguments?
   During how many days in the last month, was a specific causality actor process with name A is executed a process with name B at the early startup stage?
Event entities characteristics: Statistical tests on the unique characteristics of the executed process. Non-limiting examples of Event entities characteristics tests include the following:
   How many protected systems (tenants) reported a process with a specific SHA256 value executed at the early startup stage?
   How many protected systems reported a causality actor process with a specific SHA256 value executing a process at the early startup stage?
   How many protected systems reported a process with specific path and command line arguments executed at the early startup stage?
Entities metadata characteristics: Statistical tests on metadata values extracted from various process images in the causality tree of the process. The tests may be assigned to unique values or combinations of values from one or more processes in the causality. Several non-limiting examples of Entities metadata characteristics tests include the following:
   How many protected systems reported a process with a specific vendor signature executed at the early startup stage?
   During how many days in the last month was a specific vendor signature observed during process execution at the early startup stage?
   How many protected systems reported a causality actor process with a specific name and vendor signature executing another process with a specific name and vendor signature?

In some embodiments, detector 36 performs a given statistical test by comparing the value of a certain process characteristic to a threshold. The outcome of such a test is binary—prevalent/non-prevalent, or benign/suspicious. In other embodiments, detector 36 may perform a statistical test by comparing a process characteristic to multiple thresholds (e.g., checking a process characteristic against multiple ranges), or applying a certain function to a process characteristic, for example. The outcome of such tests is a non-binary measure of prevalence.

In some embodiments, the statistical tests in detector 36 estimate the local prevalence of process characteristics (i.e., the prevalence of the process characteristics within the processes belonging to the same tenant as the platform that runs the process). In other embodiments, the statistical tests in detector 36 estimate the global prevalence of process characteristics (i.e., the prevalence of the process characteristics within the processes belonging to multiple tenants, e.g., all tenants). In yet other embodiments, detector 36 may combine local and global prevalence estimates.

Based on the results of the statistical tests of detector 36, processor 44 decides whether the process is suspected of performing the execution phase of a persistent threat, at a suspicion checking stage 70. If the process is not suspicious, processor 28 proceeds to dropping stage 58, and the method terminates.

If the process is considered suspicious based on the statistical tests, processor 28 proceeds to estimate the severity of the suspicion, at a severity estimation stage 72. Processor 28 typically runs one or more cyber feature checks 40 for this purpose. In some embodiments, cyber feature checks 40 may evaluate any suitable rule or heuristic to estimate the severity of the suspicion that the process indeed performs the execution phase of a persistent threat. Non-limiting examples of cyber feature checks include the following:
Is the entropy of the process image file high or low?
Is the process image file name, as described in its metadata, different from the process file name?
Is the process image file signature valid?
Is the process executed with elevated privileges?
Is there an injected thread in the causality process?
If the causality process an OS executable (e.g., a Windows system binary), is it related to a persistence mechanism in the OS?

The severity may be expressed using a scale of low/medium/high, or in any other suitable way.

At a mechanism identification stage 76, processor 28 may attempt to identify which persistence mechanism was used by the attacker in the setup phase of the attack, i.e., which OS persistence mechanism was abused to enable the process to survive boot. Identifying the persistence mechanism is effective in identifying new types of attacks. For example, it has been found that each persistence mechanism tends to have one or more fixed parent processes. When these processes spawn other processes in the early startup stage, this event indicates with high confidence that a persistence was setup using a specific mechanism of the OS. This correlation enables processor 28 to identify the specific mechanism employed by a malicious threat actor.

At an alerting stage 80, processor 28 issues an alert that notifies a user or another system of the suspected process. The alert may specify, for example, a severity measure, an identified persistence mechanism, and/or any other suitable information.

The method flow of FIG. 2 is an example flow that is chosen purely for the sake of conceptual clarity. In alternative embodiments, any other suitable flow can be used.

Although the embodiments described herein mainly address detection of persistent threats using analysis of process execution events, the methods and systems described herein can be used to identify loading of drivers or other software modules (e.g., malicious DLLs).

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A cyber-security method, comprising:
selecting for analysis a software process running in a computing platform;
classifying the process into a class among a set of classes, depending on (i) whether a security identifier of the process is unique, and (ii) whether a root parent process of the process is an operating-system executable process;
applying one or more statistical tests to the process, the statistical tests depending on the class; and
based on a result of the statistical tests, deciding that the process is suspected of being a malicious process that has been set-up to persist following reboot of the computing platform, and initiating a responsive action.

2. The method according to claim 1, wherein selecting the process comprises identifying that the process was initiated within a defined time duration from booting of the computing platform.

3. The method according to claim 1, wherein classifying the process comprises:
upon finding that the security identifier is unique, deciding that the security identifier is indicative that the process was initiated automatically by an operating system; and
upon finding that the security identifier is non-unique, deciding that the security identifier is indicative that the process was not initiated automatically by the operating system.

4. The method according to claim 1, further comprising, upon deciding that the process is suspected of being a malicious process, running one or more cyber feature tests to assess a severity measure for the process.

5. The method according to claim 1, further comprising, upon deciding that the process is suspected of being a malicious process, determining a persistence mechanism that was used for setting up persistence for the process.

6. A cyber-security system, comprising:
an input interface, configured to receive events indicative of software processes that run in one or more computing platforms; and
one or more processors, configured to:
select for analysis a software process running in a computing platform;
classify the process into a class among a set of classes, depending on (i) whether a security identifier of the process is unique, and (ii) whether a root parent process of the process is an operating-system executable process;
apply one or more statistical tests to the process, the statistical tests depending on the class; and
based on a result of the statistical tests, decide that the process is suspected of being a malicious process that has been set-up to persist following reboot of the computing platform, and initiate a responsive action.

7. The system according to claim 6, wherein the one or more processors are configured to select the process by identifying that the process was initiated within a defined time duration from booting of the computing platform.

8. The system according to claim 6, wherein the one or more processors are configured to classify the process by:
upon finding that the security identifier is unique, deciding that the security identifier is indicative that the process was initiated automatically by an operating system; and
upon finding that the security identifier is non-unique, deciding that the security identifier is indicative that the process was not initiated automatically by the operating system.

9. The system according to claim 6, wherein the one or more processors are configured to, upon deciding that the process is suspected of being a malicious process, run one or more cyber feature tests to assess a severity measure for the process.

10. The system according to claim 6, wherein the one or more processors are configured to, upon deciding that the process is suspected of being a malicious process, determine a persistence mechanism that was used for setting up persistence for the process.

11. A computer software product, the product comprising a tangible non-transitory computer-readable medium in which program instructions are stored, which instructions, when read by one or more processors, cause the one or more processors to:
select for analysis a software process running in a computing platform;
classify the process into a class among a set of classes, depending on (i) whether a security identifier of the process is unique, and (ii) whether a root parent process of the process is an operating-system executable process;
apply one or more statistical tests to the process, the statistical tests depending on the class; and
based on a result of the statistical tests, decide that the process is suspected of being a malicious process that has been set-up to persist following reboot of the computing platform, and initiate a responsive action.

12. The product according to claim 11, wherein the instructions cause the one or more processors to select the process by identifying that the process was initiated within a defined time duration from booting of the computing platform.

13. The product according to claim 11, wherein the instructions cause the one or more processors to classify the process by:
upon finding that the security identifier is unique, deciding that the security identifier is indicative that the process was initiated automatically by an operating system; and
upon finding that the security identifier is non-unique, deciding that the security identifier is indicative that the process was not initiated automatically by the operating system.

14. The product according to claim 11, wherein the instructions cause the one or more processors to, upon deciding that the process is suspected of being a malicious process, run one or more cyber feature tests to assess a severity measure for the process.

15. The product according to claim 11, wherein the instructions cause the one or more processors to, upon deciding that the process is suspected of being a malicious process, determine a persistence mechanism that was used for setting up persistence for the process.
